(19) United States
(12) Patent Application Publication
(10) Pub. No.: US 2026/0229745 A1
(43) Pub. Date: Aug. 6, 2026

(54) INSULATING ADHESIVE, TAB ASSEMBLY, BATTERY CELL, AND ELECTRIC DEVICE

(71) Applicant: Ningde Amperex Technology Limited, Ningde (CN)

(72) Inventors: Biao WU, Ningde (CN); Yuting SHEN, Ningde (CN); Chuantao SONG, Ningde (CN); Peipei GUO, Ningde (CN)

(73) Assignee: Ningde Amperex Technology Limited, Ningde (CN)

(21) Appl. No.: 19/531,876

(22) Filed: Feb. 6, 2026

(30) Foreign Application Priority Data
Feb. 6, 2025 (CN) 202510133199.3

(51) Int. Cl. H01M 50/586; H01M 50/178; H01M 50/197; H01M 50/533

(52) U.S. Cl. CPC H01M 50/586; H01M 50/178; H01M 50/197; H01M 50/533

(57) ABSTRACT

An insulating adhesive includes a base layer and a surface layer. Along the thickness direction of the base layer, at least one side of the base layer is connected to the surface layer. A thickness ratio of the surface layer to the base layer is 1 to 4, and a melt index of the surface layer (at 230° C., 2.16 kg) is 4 g/10 min to 20 g/10 min. By setting the melt index of the surface layer and the thickness ratio of the surface layer to the base layer, the flowability upon melting of the surface layer is improved, and the thickness of the surface layer is increased, thereby expanding the adhesive overflow mass formed upon melting of the surface layer, enhancing the encapsulation tensile strength of the insulating adhesive under normal temperature conditions, improving the encapsulation reliability of the battery cell under normal temperature conditions.

### CROSS-REFERENCE TO RELATED APPLICATION

This application claims priority to Chinese patent application 202510133199.3, filed on Feb. 6, 2025, the contents of which are incorporated herein by reference in its entirety.

### TECHNICAL FIELD

The present application relates to the field of energy storage technologies, and particularly to an insulating adhesive, a tab assembly, a battery cell, and an electric device.

### BACKGROUND

With the continuous renewal and development of lithium-ion battery technologies, the application fields of lithium-ion batteries have been constantly expanding. Consequently, safety issues related to battery cells have attracted increasing public attention. Safety accidents characterized by thermal runaway of lithium-ion batteries triggered by external short circuits have occurred frequently, posing certain obstacles to the development of lithium-ion batteries. How to address the safety issues of battery cells has become an unavoidable challenge in the current lithium-ion battery industry.

### SUMMARY

In view of this, it is necessary to provide an insulating adhesive, a tab assembly, a battery cell, and an electric device, so as to enhance safety.

An embodiment of the present application provides an insulating adhesive, including a base layer and a surface layer. Along the thickness direction of the base layer, at least one side of the base layer is connected to the surface layer. A thickness ratio of the surface layer to the base layer is 1 to 4, and a melt index of the surface layer at 230° C. under a load of 2.16 kg is 4 g/10 min to 20 g/10 min. By setting the melt index of the surface layer and the thickness ratio of the surface layer to the base layer, the flowability of the surface layer upon melting is improved, the effective encapsulation area and uniformity of fusion upon melting of the surface layer are increased, and a tighter adhesive overflow mass is formed at the encapsulation edge, thereby enhancing the encapsulation tensile strength of the insulating adhesive under normal temperature conditions and improving the encapsulation reliability of the battery cell under normal temperature conditions. When the battery cell experiences thermal runaway and/or pressure relief, the high flowability of the surface layer at high temperatures allows the encapsulation strength of the battery cell to decrease rapidly, enabling high-temperature gases inside the battery cell to quickly release pressure and dissipate heat at the surface layer, thus improving heat dissipation efficiency and further enhancing the safety performance of the battery cell.

In one or more optional embodiments, the thickness ratio of the surface layer to the base layer is 1.5 to 3. By further regulating the thickness of the surface layer to regulate the amount of melting, the effective area and uniformity of sealing are increased. This is conducive to enhancing the encapsulation reliability of the battery cell under normal temperature conditions and, on the basis of increasing the area of the pressure relief channel after expansion of the battery cell, achieving rapid pressure relief and heat dissipation, further improving heat dissipation efficiency and enhancing the thermal box window of the battery cell.

In one or more optional embodiments, the melt index of the surface layer at 230° C. under a load of 2.16 kg is 6 g/10 min to 14 g/10 min. This easily meets the requirements for high-temperature flowability and facilitates the control of the encapsulation thickness, further improving the encapsulation reliability of the battery cell under normal temperature conditions and the safety performance of the battery cell.

In one or more optional embodiments, the melt index of the surface layer at 230° C. under a load of 2.16 kg is 7.1 g/10 min to 12 g/10 min. This makes it easier to meet the requirements for high-temperature flowability and achieve more convenient control of the encapsulation thickness, further enhancing the encapsulation reliability of the battery cell under normal temperature conditions and improving the safety performance of the battery cell.

In one or more optional embodiments, the melting point range of the surface layer is 90° C. to 120° C. This is conducive to rapid formation of a pressure relief channel upon melting, improving the heat dissipation efficiency of the battery cell.

In one or more optional embodiments, the surface layer has at least a first melting point and a second melting point, where the range of the first melting point A is 50° C.≤A≤120° C., and the range of the second melting point Bis 120° C.<B≤170° C. By providing multiple melting points, melting can occur within the temperature ranges corresponding to the first melting point and the second melting point, thereby effectively regulating the melting pressure relief points of the insulating adhesive. This is further conducive to rapid formation of a pressure relief channel and improving the heat dissipation efficiency of the battery cell.

In one or more optional embodiments, at 230° C. under a load of 2.16 kg, the melt index of the base layer is less than that of the surface layer, and the base layer has a melt index range of 0.1 g/10 min to 5 g/10 min, reducing the flowability of the base layer during melting and supporting the surface layer. This is conducive to enhancing the sealing performance and insulating properties of the battery cell. A low melt index of the base layer helps reduce the impact of thermal curling deformation on the appearance of the exposed portion of the insulating adhesive. Moreover, during the current conduction process of the tab, Joule heat is easily generated, and the base layer provides insulation due to its high melting point and low melt flow index.

In one or more optional embodiments, the surface layer satisfies at least one of the following conditions: a number-average molecular weight Mn of the surface layer is 10,000 g/mol to 130,000 g/mol. If the number-average molecular weight of the surface layer is less than 10,000 g/mol, the surface layer with excessively low melt viscosity is not conducive to processing and molding, and this tends to cause excessively high flowability upon melting, thereby reducing the encapsulation reliability of the battery cell under normal temperature conditions. If the number-average molecular weight of the surface layer is greater than 130,000 g/mol, the surface layer with excessively high melt viscosity is not conducive to processing and molding, and this tends to increase the brittleness of the surface layer, making it prone to cracking under external forces. By limiting the number-average molecular weight Mn of the surface layer to 10,000 g/mol to 130,000 g/mol, the encapsulation reliability of the battery cell under normal temperature conditions and the mechanical strength of the surface layer are improved, and this is conducive to controlling the melting point and melt index of the surface layer and effectively regulating the melting pressure relief point of the insulating adhesive. The weight-average molecular weight Mw of the surface layer is 100,000 g/mol to 800,000 g/mol. If the weight-average molecular weight of the surface layer is less than 100,000 g/mol, the mechanical strength of the surface layer is low. If the weight-average molecular weight of the surface layer is greater than 800,000 g/mol, the melt viscosity of the surface layer is too high, unfavorable for flowing. By limiting the weight-average molecular weight Mw of the surface layer to 100,000 g/mol to 800,000 g/mol, the encapsulation reliability of the battery cell under normal temperature conditions and the mechanical strength of the surface layer are improved, and this is conducive to controlling the melting point and melt index of the surface layer and effectively regulating the melting pressure relief point of the surface layer. The ratio Mw/Mn of 3 to 10 increases the polydispersity index of the material, broadens the melting point range of the surface layer, increases the proportion of low melting point or low molecular weight materials, and adjusts the melt index. This is conducive to increased material flowability at high temperatures, rapid melting upon reaching the melting point, and formation of a pressure relief channel upon collapse of the surface layer structure, thereby improving the heat dissipation efficiency of the battery cell.

In one or more optional embodiments, the melting point of the base layer is higher than that of the surface layer. The base layer has a melting point range of 140° C. to 220° C. and can supports the surface layer, lowering the risk of contact short circuits between the tab and the metal layer of the battery cell casing or between electrode sheets of different polarities caused by the melting of the base layer, and this is conducive to enhancing the insulating properties of the insulating adhesive.

In one or more optional embodiments, the number-average molecular weight of the base layer is at least 70,000 g/mol. This is conducive to enhancing the insulating properties and mechanical strength of the insulating adhesive and reducing damage to the sealing portion during drop events.

In one or more optional embodiments, the surface layer has a first crystallinity and a second crystallinity, where the first crystallinity is 1% to 30%, and the second crystallinity is 0.01% to 5%. Materials with high first crystallinity have stronger intermolecular interactions and generally higher melting points, and materials with low second crystallinity have weaker intermolecular interactions. As the temperature rises, these low-crystallinity components melt first, disrupting the ordered structure. These low-crystallinity components are uniformly distributed in the surface layer, and their melting accelerates the collapse and melting of the overall surface layer structure. This is conducive to controlling the melting of the surface layer within the temperature ranges corresponding to the first melting point and the second melting point, effectively regulating the melting pressure relief point of the insulating adhesive.

In one or more optional embodiments, a crystallinity of the insulating adhesive is 2% to 35%. If the crystallinity of the insulating adhesive is less than 2%, the flowability upon melting is high, easily leading to leakage in the battery cell; if the crystallinity of the insulating adhesive is greater than 35%, the flowability upon melting is low, affecting the rapid formation of a pressure relief channel, reducing heat dissipation efficiency, and being detrimental to improving the safety performance of the battery cell. By limiting the overall crystallinity of the insulating adhesive to 2% to 35%, it is conducive to controlling the melting of the insulating adhesive within the temperature ranges corresponding to the first melting point and the second melting point, effectively regulating the melting pressure relief point of the insulating adhesive. This is conducive to rapid formation of a pressure relief channel in the battery cell, improving heat dissipation efficiency and safety performance, and achieving sealing reliability of the insulating adhesive.

An embodiment of the present application provides a tab assembly, including a tab and the insulating adhesive according to any one of the embodiments, where the insulating adhesive is connected to the tab.

An embodiment of the present application provides a battery cell, including a battery cell casing, an electrode assembly, a tab, and the insulating adhesive according to any one of the embodiments. The battery cell casing includes a main body portion and a sealing portion, the electrode assembly is disposed within the main body portion, and the tab is connected to the electrode assembly and extends out of the sealing portion. The insulating adhesive is located between the tab and the battery cell casing, and the surface layer adheres to the battery cell casing or the tab.

In one or more optional embodiments, a tensile strength range of the insulating adhesive at 25° C. is 5 N/mm to 10 N/mm, enhancing the encapsulation tensile strength of the insulating adhesive under normal temperature conditions and improving the encapsulation reliability of the battery cell under normal temperature conditions.

In one or more optional embodiments, the tensile strength range of the insulating adhesive at 95° C. is 0.2 N/mm to 2 N/mm. Under the operating condition of the battery cell at 95° C., the encapsulation reliability still meets the requirements, reducing the occurrence of leakage.

In one or more optional embodiments, the tensile strength range of the insulating adhesive at 120° C. is 0.01 N/mm to 0.2 N/mm. This is further conducive to rapid formation of a pressure relief channel after expansion of the battery cell, improving heat dissipation efficiency, and thereby enhancing the safety performance of the battery cell.

In one or more optional embodiments, the tab includes a first segment, a second segment, and a third segment. At least a portion of the first segment is connected to the electrode assembly. The second segment is connected in a bent manner to the first segment, and the second segment accounting for 5% to 70% of the thickness of the battery cell is conducive to lowering the risk of tab breakage during drop events. By setting the melt index of the insulating adhesive and the thickness ratio of the surface layer to the base layer, the risk of short circuit due to contact between the second segment and the metal layer of the battery cell casing or electrode sheets of different polarities under extreme conditions is reduced. The third segment is connected in a bent manner to the second segment, and a portion of the third segment extends out of the sealing portion.

In one or more optional embodiments, the sealing portion includes two adhesive layers, and the sealing portion includes a first region not overlapping with the insulating adhesive. The two adhesive layers in the first region are adhesively connected, and twice the thickness of the base layer is less than a sum of the thicknesses of the two adhesive layers in the first region, or the sum of the thicknesses of the base layers on two sides of the tab is less than the sum of the thicknesses of the two adhesive layers in the first region, reducing the occurrence of pore channels in the sealing portion and lowering the risk of leakage and short circuit.

In one or more optional embodiments, a sum of the thickness of the insulating adhesive and the thickness of the adhesive layer is less than the sum of the thicknesses of the adhesive layers in the two first regions, further reducing the occurrence of pore channels in the sealing portion and lowering the risk of leakage and short circuit.

An embodiment of the present application provides an electric device, including the battery cell according to any one of the embodiments.

### BRIEF DESCRIPTION

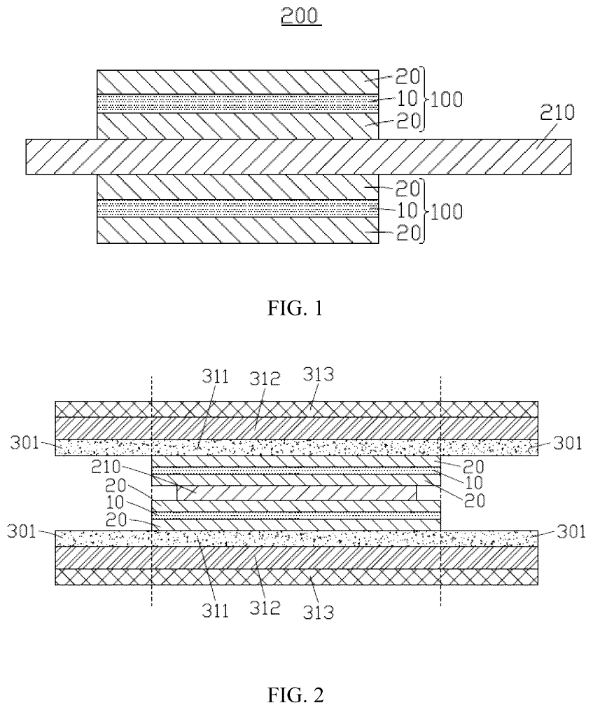

FIG. 1 is a schematic structural diagram of a tab assembly according to some embodiments.

FIG. 2 is a partial schematic diagram of a battery cell according to some 5 embodiments.

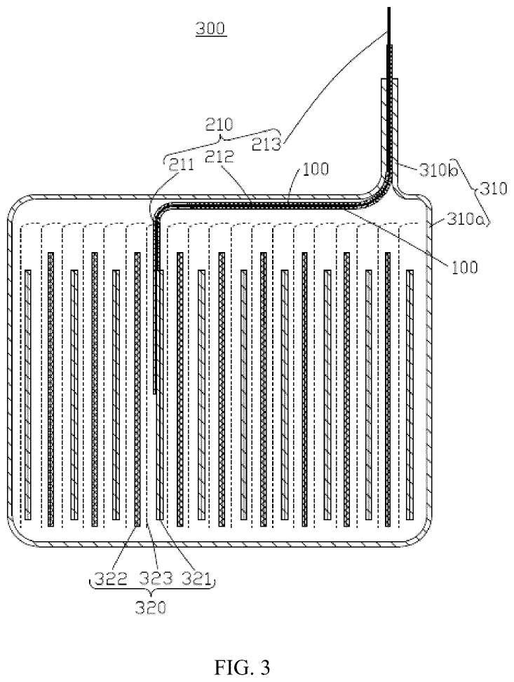

FIG. 3 is a cross-sectional schematic diagram of a battery cell according to some embodiments.

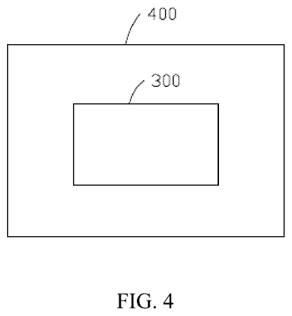

FIG. 4 is a schematic structural diagram of an electric device according to some embodiments.

Reference signs of main components

| | |
|---|---|
| Insulating adhesive | 100 |
| Base layer | 10 |
| Surface layer | 20 |
| Tab assembly | 200 |
| Tab | 210 |
| First segment | 211 |
| Second segment | 212 |
| Third segment | 213 |
| Battery cell | 300 |
| Battery cell casing | 310 |
| Main body portion | 310a |
| Sealing portion | 310b |
| Adhesive layer | 311 |
| Metal layer | 312 |
| Outer layer | 313 |
| Electrode assembly | 320 |
| First electrode sheet | 321 |
| Second electrode sheet | 322 |
| Separator | 323 |
| First region | 301 |
| Electric device | 400 |

The following specific embodiments will further describe the present application in conjunction with the above drawings.

### Description of Embodiments

The following specific embodiments are exemplary and not restrictive, and are intended to provide a basic understanding of the present application, not to confirm key or decisive elements of the present application or to limit the scope of protection. As long as there is no structural conflict, the technical features mentioned in each embodiment can be combined in any manner.

When a component is considered to be “disposed on” another component, it may be directly disposed on the other component or there may be an intervening component. When a component is considered to be “connected to” another component, it may be directly connected to the other component or there may be an intervening component.

Unless otherwise defined, the term “multiple” as used herein to describe the number of components specifically refers to two or more of such components.

Some embodiments of the present application will be described below with reference to the drawings. In the absence of conflict, the following embodiments and features in the embodiments can be combined with each other.

Referring to FIG. 1 to FIG. 3, the present application provides an insulating adhesive 100, including a base layer 10 and a surface layer 20. Along the thickness direction of the base layer 10, at least one side of the base layer 10 is connected to the surface layer 20.

Optionally, along the thickness direction of the base layer 10, one side of the base layer 10 is connected to the surface layer 20.

Optionally, along the thickness direction of the base layer 10, two sides of the base layer 10 are connected to the surface layer 20. The present application takes the example of two sides of the base layer 10 being connected to the surface layer 20 for illustration.

It can be understood that, in some embodiments, the thicknesses of the surface layers 20 on two sides of the base layer 10 are equal. In other embodiments, there is a tolerance in the thicknesses of the surface layers 20 on two sides of the base layer 10.

In some embodiments, a melt index of the surface layer 20 at 230° C. under a load of 2.16 kg is 4 g/10 min to 20 g/10 min. If the melt index of the surface layer 20 at 230° C. under a load of 2.16 kg is less than 4 g/10 min, the flowability upon melting of the surface layer 20 is low. This is not conducive to expanding the adhesive overflow mass formed upon melting of the surface layer 20, so that the encapsulation tensile strength of the insulating adhesive 100 under normal temperature conditions is reduced, the encapsulation reliability of the battery cell 300 under normal temperature conditions is lowered, and the rapid formation of a pressure relief channel after expansion of the battery cell 300 is affected, reducing heat dissipation efficiency and being detrimental to improving the safety performance of the battery cell 300. If the melt index of the surface layer 20 at 230° C. under a load of 2.16 kg is greater than 20 g/10 min, the flowability upon melting of the surface layer 20 is excessively high, easily leading to leakage in the battery cell 300 and affecting the sealing performance of the battery cell 300. By limiting the melt index of the surface layer 20 at 230° C. under a load of 2.16 kg to 4 g/10 min to 20 g/10 min, the flowability upon melting of the surface layer 20 is adjusted, and a tighter adhesive overflow mass is formed at the sealing edge, enhancing the encapsulation tensile strength of the insulating adhesive 100 under normal temperature conditions, and improving the encapsulation reliability of the battery cell 300 under normal temperature conditions. When the battery cell 300 experiences thermal runaway and/or pressure relief, the high flowability of the surface layer 20 at high temperatures allows the encapsulation strength of the battery cell 300 to decrease rapidly, enabling high-temperature gases inside the battery cell 300 to quickly release pressure and dissipate heat at the surface layer 20, improving heat dissipation efficiency and thereby enhancing the safety performance of the battery cell 300.

Optionally, the melt index of the surface layer 20 at 230° C. under a load of 2.16 kg may be any one of 4 g/10 min, 5 g/10 min, 6 g/10 min, 7 g/10 min, 8 g/10 min, 9 g/10 min, 10 g/10 min, 11 g/10 min, 12 g/10 min, 13 g/10 min, 14 g/10 min, 15 g/10 min, 16 g/10 min, 17 g/10 min, 18 g/10 min, 19 g/10 min, 20 g/10 min, or a range composed of any two of these values.

In some embodiments, a thickness ratio of the surface layer 20 to the base layer 10 is 1 to 4. During the encapsulation process, along the thickness direction of the battery cell casing 310, two adhesive layers 311 are bonded and have a first thickness; the portion of the insulating adhesive 100 extending on two sides along the width direction of the tab 210 is bonded and has a second thickness; the insulating adhesive 100 on two sides along the thickness direction of the tab 210, together with the tab 210, have a third thickness. The thickness ratio of the surface layer 20 to the base layer 10 less than is likely to lead to insufficient material filling in the encapsulation region with a high thickness difference among the first thickness, the second thickness, and the third thickness, resulting in poor encapsulation due to fusion between the base layer 10 and the adhesive layer 311 of the battery cell casing 310 on the other side. These fusion regions exhibit poor flowability at high temperatures, so that the effective pressure relief area is reduced, the encapsulation tensile strength of the insulating adhesive 100 under normal temperature conditions is lowered, and the encapsulation reliability of the battery cell 300 under normal temperature conditions is reduced. If the thickness ratio of the surface layer 20 to the base layer 10 is greater than 4, the amount of the surface layer 20 melted becomes excessively large, and the adhesive overflow mass formed after encapsulation of the surface layer 20 is too large, affecting the rapid formation of a pressure relief channel after expansion of the battery cell 300, thereby reducing heat dissipation efficiency, and being detrimental to improving the safety performance of the battery cell 300. By limiting the thickness ratio of the surface layer 20 to the base layer 10 to 1 to 4, the thickness of the surface layer 20 and its melting amount are increased. The melted surface layer 20, having high flowability, can quickly fill positions with thickness differences in the encapsulation region, avoiding the occurrence of unencapsulated pore channels, and increasing the effective area and uniformity of encapsulation. This is conducive to enhancing the encapsulation reliability of the battery cell 300 under normal temperature conditions. As an intermediate medium layer for encapsulation, the increased thickness of the surface layer 20 increases the area of the pressure relief channel after expansion of the battery cell 300 and is conducive to improving heat dissipation efficiency.

Optionally, the thickness ratio of the surface layer 20 to the base layer 10 may be any one of 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, or a range composed of any two of these values.

By setting the melt index of the surface layer 20 and the thickness ratio of the surface layer 20 to the base layer 10, the flowability upon melting of the surface layer 20 is improved, the thickness of the surface layer 20 is increased, the effective encapsulation area and uniformity of fusion upon melting of the surface layer 20 are increased, and a tighter adhesive overflow mass is formed at the encapsulation edge, thereby enhancing the encapsulation tensile strength and reliability of the battery cell 300 under normal temperature conditions. When the battery cell 300 experiences thermal runaway and/or pressure relief, the high flowability of the surface layer 20 at high temperatures allows the encapsulation strength of the battery cell 300 to decrease rapidly, enabling high-temperature gases inside the battery cell 300 to quickly release pressure and dissipate heat at the surface layer 20, thus improving heat dissipation efficiency and further enhancing the safety performance of the battery cell 300.

In some embodiments, the thickness ratio of the surface layer 20 to the base layer 10 is 1.5 to 3. By further adjusting the thickness of the surface layer 20 to regulate the amount of melting, the effective area and uniformity of sealing are increased. This is conducive to enhancing the encapsulation reliability of the battery cell 300 under normal temperature conditions and, on the basis of increasing the area of the pressure relief channel after expansion of the battery cell 300, achieving rapid pressure relief and heat dissipation, further improving heat dissipation efficiency and the thermal box window.

In some embodiments, the melt index of the surface layer 20 at 230° C. under a load of 2.16 kg is 6 g/10 min to 14 g/10 min. This easily meets the requirements for high-temperature flowability and facilitates the control of the sealing thickness, further improving the encapsulation reliability of the battery cell 300 under normal temperature conditions and the safety performance of the battery cell 300.

In some embodiments, the melt index of the surface layer 20 at 230° C. under a load of 2.16 kg is 7.1 g/10 min to 12 g/10 min. This makes it easier to meet the requirements for high-temperature flowability and achieve more convenient control of the sealing thickness, further enhancing the encapsulation reliability of the battery cell 300 under normal temperature conditions and improving the safety performance of the battery cell 300.

In some embodiments, the melting point range of the surface layer 20 is 90° C. to 120° C. This is conducive to rapid formation of a pressure relief channel upon melting, improving the heat dissipation efficiency of the battery cell 300.

Optionally, the melting point of the surface layer 20 may be any one of 90° C., 92° C., 94° C., 96° C., 98° C., 100° C., 102° C., 104° C., 106° C., 108° C., 110° C., 112° C., 114° C., 116° C., 118° C., 120° C., or a range composed of any two of these values.

In some embodiments, the surface layer 20 has at least a first melting point and a second melting point, where the range of the first melting point A is 50° C.≤A≤120° C., and the range of the second melting point Bis 120° C.<B≤170° C. By providing multiple melting point ranges, the surface layer 20 can melt within the temperature ranges corresponding to the first melting point and the second melting point, thereby effectively regulating the melting pressure relief point of the insulating adhesive 100 and improving the heat dissipation efficiency of the battery cell 300.

Optionally, the first melting point may be any one of 50° C., 55° C., 60° C., 65° C., 70° C., 75° C., 80° C., 85° C., 90° C., 95° C., 100° C., 105° C., 110° C., 115° C., 119° C., 120° C., or a range composed of any two of these values.

Optionally, the second melting point may be any one of 120.1° C., 125° C., 130° C., 135° C., 140° C., 145° C., 150° C., 155° C., 160° C., 165° C., 170° C., or a range composed of any two of these values.

In some embodiments, the melting point of the base layer 10 is higher than that of the surface layer 20, and the base layer 10 has a melting point range of 140° C. to 220° C. and supports the surface layer 20, lowering the risk of contact short circuit between the tab 210 and the metal layer 312 of the battery cell casing 310 or between electrode sheets of different polarities caused by the melting of the base layer 10, and this is conducive to enhancing the insulating properties of the insulating adhesive 100.

Optionally, the melting point of the base layer 10 may be any one of 140° C., 145° C., 150° C., 155° C., 160° C., 165° C., 170° C., 175° C., 180° C., 185° C., 190° C., 195° C., 200° C., 205° C., 210° C., 215° C., 220° C., or a range composed of any two of these values.

In some embodiments, the base layer 10 has a melt index range of 0.1 g/10 min to 5 g/10 min at 230° C. under a load of 2.16 kg, reducing the flowability of the base layer 10 during melting and supporting the surface layer 20. This is conducive to enhancing the sealing performance of the battery cell 300. A low melt index of the base layer 10 helps reduce the impact of thermal curling deformation on the appearance of the exposed portion of the insulating adhesive 100. Moreover, during the current conductive process of the tab, Joule heat is easily generated, and the base layer 10 provides insulation due to its high melting point and low melt flow index.

Optionally, the melt index of the base layer 10 at 230° C. under a load of 2.16 kg may be any one of 0.1 g/10 min, 1 g/10 min, 2 g/10 min, 3 g/10 min, 4 g/10 min, 5 g/10 min, or a range composed of any two of these values.

In some embodiments, the number-average molecular weight of the base layer 10 is at least 70,000 g/mol. This is conducive to enhancing the insulating properties and mechanical strength of the insulating adhesive 100 and reducing damage to the sealing portion 310b during drop events.

In some embodiments, the surface layer 20 includes a first crystallinity and a second crystallinity, where the first crystallinity is 1% to 30%, and the second crystallinity is 0.01% to 5%. Materials with high first crystallinity have stronger intermolecular interactions and generally higher melting points, and materials with low second crystallinity have weaker intermolecular interactions. As the temperature rises, these low-crystallinity components melt first, disrupting the ordered structure. These low-crystallinity components are uniformly distributed in the surface layer, and their melting accelerates the collapse and melting of the overall surface layer structure. This is conducive to regulating the melting of the surface layer within the temperature ranges corresponding to the first melting point and the second melting point, effectively regulating the melting pressure relief point of the insulating adhesive 100.

Optionally, the first crystallinity may be any one of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, or a range composed of any two of these values.

Optionally, the second crystallinity may be any one of 0.01%, 0.03%, 0.05%, 0.07%, 0.09%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, or a range composed of any two of these values.

In some embodiments, a crystallinity of the insulating adhesive 100 is 2% to 35%. If the crystallinity of the insulating adhesive 100 is less than 2%, the flowability upon melting is excessively high, easily leading to leakage in the battery cell 300; if the crystallinity of the insulating adhesive 100 is greater than 35%, the flowability upon melting is low, affecting the rapid formation of a pressure relief channel, reducing heat dissipation efficiency, and being detrimental to improving the safety performance of the battery cell 300. By limiting the overall crystallinity of the insulating adhesive 100 to 2% to 35%, it is conducive to controlling the melting of the insulating adhesive 100 within the temperature ranges corresponding to the first melting point and the second melting point, effectively regulating the melting pressure relief point of the insulating adhesive 100. This is conducive to rapid formation of a pressure relief channel in the battery cell 300, improving heat dissipation efficiency and safety performance, and achieving sealing reliability of the insulating adhesive 100.

Optionally, the first crystallinity may be any one of 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, or a range composed of any two of these values.

In some embodiments, the number-average molecular weight Mn of the surface layer 20 is 10,000 g/mol to 130,000 g/mol. If the number-average molecular weight of the surface layer 20 is less than 10,000 g/mol, the surface layer 20 with excessively low melt viscosity is not conducive to processing and molding, and this tends to cause excessively high flowability upon melting, thereby reducing the encapsulation reliability of the battery cell 300 under normal temperature conditions. If the number-average molecular weight of the surface layer 20 is greater than 130,000 g/mol, the surface layer 20 with excessively high melt viscosity is not conducive to processing and molding, and this tends to increase the brittleness of the surface layer 20, making it prone to cracking under external force. By limiting the number-average molecular weight Mn of the surface layer 20 to 10,000 g/mol to 130,000 g/mol, the encapsulation reliability of the battery cell 300 under normal temperature conditions and the mechanical strength of the surface layer 20 are improved, and this is conducive to controlling the melting point and melt index of the surface layer 20 and effectively regulating the melting pressure relief point of the insulating adhesive 100.

Optionally, the number-average molecular weight Mn of the surface layer 20 may be any one of 10,000 g/mol, 20,000 g/mol, 30,000 g/mol, 40,000 g/mol, 50,000 g/mol, 60,000 g/mol, 70,000 g/mol, 80,000 g/mol, 90,000 g/mol, 100,000 g/mol, 110,000 g/mol, 120,000 g/mol, 130,000 g/mol, or a range composed of any two of these values.

In some embodiments, the weight-average molecular weight Mw of the surface layer 20 is 100,000 g/mol to 800,000 g/mol. If the weight-average molecular weight of the surface layer 20 is less than 100,000 g/mol, the mechanical strength of the surface layer 20 is low. If the weight-average molecular weight of the surface layer 20 is greater than 800,000 g/mol, the melt viscosity of the surface layer 20 is high, which is not conducive to flow. By limiting the weight-average molecular weight Mw to 100,000 g/mol to 800,000 g/mol, the encapsulation reliability of the battery cell 300 under normal temperature conditions and the mechanical strength of the surface layer 20 are improved, which is conducive to regulating the melting point and melt index of the surface layer 20 and effectively regulating the melting pressure relief point of the insulating adhesive 100.

Optionally, the weight-average molecular weight Mw of the surface layer 20 may be any one of 100,000 g/mol, 200,000 g/mol, 300,000 g/mol, 400,000 g/mol, 500,000 g/mol, 600,000 g/mol, 700,000 g/mol, 800,000 g/mol, or a range composed of any two of these values.

In some embodiments, the polydispersity index Mw/Mn of 3 to 10 increases the polydispersity index of the surface layer 20, broadens the melting point range (melting range) of the surface layer 20, and, in addition, reduces the melt index. This is conducive to increased material flowability at high temperatures, rapid melting upon reaching the melting point, and formation of a pressure relief channel upon collapse of the surface layer 20 structure, thereby improving the heat dissipation efficiency of the battery cell 300.

Optionally, the ratio range of Mw/Mn may be any one of 3, 4, 5, 6, 7, 8, 9, 10, or a range composed of any two of these values.

In some embodiments, the material of the insulating adhesive 100 includes at least one of polyolefin-based resin, acid-modified polyolefin-based resin, polyethylene, polypropylene, ethylene-based elastomer, and styrene-based elastomer.

Referring to FIG. 1, an embodiment of the present application provides a tab assembly 200, including a tab 210 and the insulating adhesive 100 according to any one of the embodiments, where the insulating adhesive 100 is connected to the tab 210.

In some embodiments, along the thickness direction of the tab 210, the tab 210 is disposed between two insulating adhesives 100.

Referring to FIG. 2 and FIG. 3, an embodiment of the present application provides a battery cell 300, including a battery cell casing 310, an electrode assembly 320, a tab 210, and an insulating adhesive 100. The electrode assembly 320 is disposed within the battery cell casing 310, and the tab 210 is connected to the electrode assembly 320 and extends out of the battery cell casing 310. Along the thickness direction of the tab 210, the tab 210 is disposed between two insulating adhesives 100. The insulating adhesive 100 is located between the tab 210 and the battery cell casing 310, and the surface layer 20 adheres to the battery cell casing 310 and/or the tab 210.

In some embodiments, the battery cell casing 310 may be a packaging bag obtained by encapsulating with a packaging film (such as an aluminum-plastic film), that is, the battery cell 300 is a pouch cell.

In some embodiments, a tensile strength range of the insulating adhesive 100 at 25° C. is 5 N/mm to 10 N/mm, enhancing the encapsulation tensile strength of the insulating adhesive 100 under normal temperature conditions and improving the encapsulation reliability of the battery cell 300 under normal temperature conditions. A tensile strength exceeding 10 N/mm is likely to cause the packaging bag to rupture.

Optionally, at 25° C., the tensile strength between the insulating adhesive 100 and the sealing portion 310b and/or the tab 210 may be any one of 5 N/mm, 5.5 N/mm, 6 N/mm, 6.5 N/mm, 7 N/mm, 7.5 N/mm, 8 N/mm, 8.5 N/mm, 9 N/mm, 9.5 N/mm, 10 N/mm, or a range composed of any two of these values.

In some embodiments, the tensile strength range of the insulating adhesive 100 at 95° C. is 0.2 N/mm to 2 N/mm. Under the operating condition of the battery cell 300 at 95° C., the encapsulation reliability still meets the requirements, reducing the occurrence of leakage.

Optionally, at 95° C., the tensile strength between the insulating adhesive 100 and the sealing portion 310b and/or the tab 210 may be any one of 0.2 N/mm, 0.3 N/mm, 0.4 N/mm, 0.5 N/mm, 0.6 N/mm, 0.7 N/mm, 0.8 N/mm, 0.9 N/mm, 1.0 N/mm, 1.1 N/mm, 1.2 N/mm, 1.3 N/mm, 1.4 N/mm, 1.5 N/mm, 1.6 N/mm, 1.7 N/mm, 1.8 N/mm, 1.9 N/mm, 2.0 N/mm, or a range composed of any two of these values.

In some embodiments, the tensile strength range of the insulating adhesive 100 at 120° C. is 0.01 N/mm to 0.2 N/mm. This is further conducive to rapid formation of a pressure relief channel after expansion of the battery cell 300, improving heat dissipation efficiency, and thereby enhancing the safety performance of the battery cell 300.

Optionally, at 120° C., the tensile strength between the insulating adhesive 100 and the sealing portion 310b and/or the tab 210 may be any one of 0.01 N/mm, 0.02 N/mm, 0.03 N/mm, 0.04 N/mm, 0.05 N/mm, 0.06 N/mm, 0.07 N/mm, 0.08 N/mm, 0.09 N/mm, 0.1 N/mm, 0.11 N/mm, 0.12 N/mm, 0.13 N/mm, 0.14 N/mm, 0.15 N/mm, 0.16 N/mm, 0.17 N/mm, 0.18 N/mm, 0.19 N/mm, 0.2 N/mm, or a range composed of any two of these values.

In some embodiments, the battery cell casing 310 includes an adhesive layer 311, a metal layer 312, and an outer layer 313 stacked together, where the metal layer 312 is disposed between the adhesive layer 311 and the outer layer 313, and the outer layer 313 is located at the outermost layer of the battery cell casing 310. The outer layer 313 may be a nylon layer or a composite layer of polyester resin (PET) and nylon, providing protection against contamination, corrosion, and external damage. The metal layer 312 may include one of aluminum and steel, serving the functions of water resistance, barrier protection, and facilitating the molding of the battery cell casing 310. The adhesive layer 311 is a heat-sealing layer and may include a polymer, where the polymer includes one of polypropylene and polyethylene. The adhesive layer 311 is used to seal the battery cell casing 310 through hot pressing and separate the metal layer 312 from the electrode assembly 320, lowering the risk of electrolyte leakage within the battery cell casing 310 corroding the metal layer 312.

In some embodiments, the battery cell casing 310 includes a main body portion 310a and a sealing portion 310b, where the main body portion 310a is connected to the sealing portion 310b. The electrode assembly 320 is disposed within the main body portion 310a, and the tab 210 extends out of the battery cell casing 310 from the sealing portion 310b.

In some embodiments, the electrode assembly 320 includes a first electrode sheet 321, a second electrode sheet 322, and a separator 323, where the separator 323 is disposed between the first electrode sheet 321 and the second electrode sheet 322. The separator 323 is used to prevent direct contact between the first electrode sheet 321 and the second electrode sheet 322, thereby lowering the risk of short circuit between the first electrode sheet 321 and the second electrode sheet 322.

In some embodiments, the electrode assembly 320 is a wound structure, that is, the first electrode sheet 321, the separator 323, and the second electrode sheet 322 are stacked in sequence and wound to form the electrode assembly 320. In other embodiments, the electrode assembly 320 may alternatively be a laminated structure, that is, the first electrode sheet 321, the separator 323, and the second electrode sheet 322 are sequentially stacked to form an electrode assembly unit, and multiple electrode assembly units are then stacked to form the electrode assembly 320. In some embodiments, the first electrode sheet 321 is a negative electrode sheet or a positive electrode sheet, and the second electrode sheet 322 is an electrode sheet of opposite polarity to the first electrode sheet 321. In the present application, the first electrode sheet 321 is taken as the positive electrode sheet and the second electrode sheet 322 as the negative electrode sheet for illustration.

In some embodiments, the tab 210 includes a first segment 211, a second segment 212, and a third segment 213, where at least a portion of the first segment 211 is connected to the first electrode sheet 321 or the second electrode sheet 322. The second segment 212 is connected in a bent manner to the first segment 211. The third segment 213 is connected in a bent manner to the second segment 212, and a portion of the third segment 213 extends out of the sealing portion 310b. A portion of the third segment 213 extends out of the insulating adhesive 100 to connect with other components for energy transmission.

In some embodiments, the first segment 211 is welded to the first electrode sheet 321 or the second electrode sheet 322. Welding methods include laser welding, ultrasonic welding, and the like.

In some embodiments, along the thickness direction of the battery cell 300, the length of the second segment 212 is 5% to 70% of the thickness of the battery cell 300. This is conducive to lowering the risk of breakage of the tab 210 during drop events. By setting the melt index of the surface layer and the thickness ratio of the surface layer to the base layer, the risk of contact short circuit of the battery cell between the second segment 212 and the metal layer 312 or electrode sheets of different polarities under extreme conditions caused by the insulating adhesive 100 failing to release pressure and melting can be reduced. Optionally, the length of the second segment 212 is any one of 5%, 10%, 15%, 20%, 25%, 30%, 35%, 40%, 45%, 50%, 55%, 60%, 65%, 70% of the thickness of the battery cell 300.

In some embodiments, along the thickness direction of the battery cell casing 310, the sealing portion 310b includes two adhesive layers 311. Along the thickness direction of the battery cell casing 310, the sealing portion 310b includes a first region 301 not overlapping with the insulating adhesive 100. The two adhesive layers 311 in the first region 301 are adhesively connected, and twice the thickness of the base layer 10 is less than the sum of the thicknesses of the two adhesive layers 311 after hot pressing, or the sum of the thicknesses of the base layers 10 on two sides of the tab 210 is less than the sum of the thicknesses of the two adhesive layers 311. Since the base layer 10 has a high melting point and is not prone to melting during the encapsulation process, an excessively large thickness of the base layer 10 may result in pore channels after encapsulation due to non-melting, leading to leakage. External moisture can easily enter the interior of the battery cell casing 310, thereby increasing the risk of short circuits. By ensuring that half of the thickness of the base layer 10 is less than the sum of the thicknesses of the two adhesive layers 311 after hot pressing, the occurrence of pore channels in the sealing portion 310b is reduced, lowering the risk of leakage and short circuit.

In some embodiments, the sum of the thickness of the insulating adhesive 100 and the thickness of the adhesive layer 311 is less than the sum of the thicknesses of the two adhesive layers 311, further reducing the occurrence of pore channels in the sealing portion 310b and lowering the risk of leakage and short circuit.

The following will further illustrate the present application through specific examples.

### 1. Specific Method for Thermal Box Test

The furnace temperature was adjusted to 25° C., the lithium-ion battery cell sample was placed in the furnace for 5 minutes, charged at 0.2 C DC to 3.0 V, left standing for 10 minutes; then charged at a constant current of 0.7 C to 4.5 V, followed by constant voltage charging to 0.025 C, and left standing for 10 minutes. Photos were taken before testing. The voltage and internal resistance were measured, a temperature sensor was attached to the surface of the battery cell, then the sample was placed into a heating furnace box, the temperature was raised to a target temperature (for example, 130° C.) at a rate of 5±2° C./min and held for 60 minutes. Photos were taken after testing. The voltage and internal resistance were measured. The battery cell not catching fire or exploding indicated that it has passed the thermal box test, and the highest temperature at which the battery cell can pass was defined as the thermal box window of the battery cell.

### 2. Test Method for High-Temperature and High-Humidity

After fully charged at 1 C, the lithium-ion battery cell was stored in a test environment with a temperature of 60±2° C. and humidity of 90±2.5% for 28 days. The lithium-ion battery cell not catching fire, exploding, smoking, or leaking indicated that it has passed the test.

### 3. Test Method for Encapsulation Tensile Strength

A battery cell casing 310 having a sealing portion 310b of 8 mm width and a tab assembly 200 were taken, and the sealing portion 310b was bonded to the tab assembly 200. One end of the tensile machine was clamped to the battery cell casing 310 and the other end was clamped to the tab 210. The tensile machine was adjusted to the test temperature at a rate of 10° C./min and held 30 seconds. Thereafter, tensile loading was applied at a speed of 175 mm/min with the two clamping ends arranged at 180 degrees until breakage, and the maximum tensile force displayed by the tensile machine was recorded.

### 4. Test Method for Melt Index

The surface layer 20 of the insulating adhesive 100 was peeled off to obtain samples of the surface layer 20 and the base layer 10. Approximately 2-10 grams of the sample was taken, with the specific weight adjustable depending on the melt index of the material and test conditions. A melt flow indexer was used, and the sample was crushed into small particles to ensure uniformity. The test temperature was set to 230° C. and the load was set to 2.16 kg. The sample was placed into the barrel of the melt flow indexer. The melt flow indexer was heated to 230° C. to melt the sample. A load of 2.16 kg was applied to extrude the molten material through a standard die. The weight of the material passing through the die over a certain period was recorded. Melt Flow Rate (MFR)=weight of material passing through the die (g)/test time (min).

### 5. Test Method for Voltage Withstand

A probe was used to press on the positive and negative tabs 210, another probe pierced the battery cell casing 310 to contact the metal layer 312 inside the battery cell casing. A voltage of 100V and a pressure of 0.35 MPa on the surface of the battery cell 300 were applied between the two probes. The measured resistance value was required to be greater than 20 MΩ for the test to be considered passed.

### 6. Test Method for Number-Average Molecular Weight

Gel Permeation Chromatography (GPC), a high-performance liquid chromatography technique, was used to measure molecular weight distribution by separating polymer chains of different molecular weights. The surface layer 20 of the insulating adhesive 100 was peeled off to obtain samples of the surface layer 20 and the base layer 10. Tetrahydrofuran (THF) was selected as the solvent, the sample was dissolved to prepare a solution of appropriate concentration (usually 0.1-1 mg/mL). The sample solution was filtered through a 0.45 μm filter to remove insoluble matter and particles. The test temperature (30° C.) and flow rate (1 mL/min) were set. The injection volume was set to 100 μL, a detector was used to record the response signal of each molecular weight component, the detection signal was converted to molecular weight through a calibration curve, and the number-average molecular weight (Mn), weight-average molecular weight (Mw), and polydispersity index (PDI) were calculated.

### 7. Test Method for Crystallinity and Melting Point

The surface layer 20 was peeled off from the insulating adhesive 100 to obtain samples of the surface layer 20 and the base layer 10. Approximately 1-3 mg of the sample was taken and placed into a crucible, and a thermal analyzer was used to test under conditions of a temperature range of 25-800° C., a scanning rate of 0.1-50 K/min, and inert gas N₂.

A group of 1,000 battery cells 300 was subjected to the dielectric withstand (voltage) test. Among the battery cells 300 that passed the voltage test, groups of 100 battery cells 300 were further subjected to the high-temperature and high-humidity test and the thermal box test.

TABLE 1

| | | Surface | | | | | | | 120° C. | | | |
|---|---|---|---|---|---|---|---|---|---|---|---|---|
| | | layer | | | | | | 95° C. | Tensile | Ther- | High- | |
| | | mel | | | | | Tensile | Tensile | strength | mal | tempera- | |
| | Thick- | index | | | First | Second | strength | strength | at | box | ture high- | Voltage |
| | ness | (g/10 | | | point | point | at 25° C. | at 95° C. | 120° C. | test | humidity | withstand |
| | ratio | min) | Mn | Mw/Mn | melting | melting | (N/mm) | (N/mm) | (N/mm) | result | test result | test result |
| Comparative | 0.5 | 2 | 140780 | 1.7 | 123 | 145 | 3.9 | 2 | 0.21 | 126 | 100% | 99.90% |
| example 1-1 | | | | | | | | | | | | |
| Comparative | 0.5 | 25 | 9845 | 13 | 47 | 98 | 7.7 | 0.2 | 0.09 | 132 | 20% | 99.30% |
| example 1-2 | | | | | | | | | | | | |
| Comparative | 5 | 2 | 140780 | 1.7 | 123 | 145 | 4.1 | 2.6 | 0.5 | 126 | 100% | 99.90% |
| example 1-3 | | | | | | | | | | | | |
| Comparative | 5 | 25 | 9845 | 13 | 47 | 98 | 7.9 | 0.2 | 0.04 | 132 | 20% | 90.10% |
| example 1-4 | | | | | | | | | | | | |
| Comparative | 1.5 | 25 | 10038 | 9 | 52 | 137 | 5.6 | 0.23 | 0.01 | 128 | 70% | 99.90% |
| example 1-5 | | | | | | | | | | | | |
| Comparative | 5 | 7.1 | 137000 | 3 | 109 | 125 | 8 | 0.6 | 0.17 | 126 | 100% | 99.90% |
| example 1-6 | | | | | | | | | | | | |
| Example 1-1 | 1.5 | 4 | 86794 | 3.7 | 118 | 123 | 7.9 | 1.7 | 0.19 | 127 | 100% | 99.90% |
| Example 1-2 | 1.5 | 5 | 98869 | 5.9 | 105 | 125 | 9.6 | 1.24 | 0.02 | 128 | 100% | 99.90% |
| Example 1-3 | 1.5 | 6 | 86685 | 7 | 90 | 131 | 8.5 | 1.21 | 0.03 | 129 | 100% | 99.90% |
| Example 1-4 | 1.5 | 7.1 | 56393 | 8.3 | 87 | 121 | 5.8 | 0.34 | 0.09 | 131 | 100% | 99.90% |
| Example 1-5 | 1.5 | 9 | 40130 | 8.6 | 79 | 145 | 5.8 | 0.27 | 0.01 | 132 | 100% | 99.90% |
| Example 1-6 | 1.5 | 12 | 30987 | 9.4 | 67 | 121 | 5.7 | 0.23 | 0.04 | 132 | 100% | 99.90% |
| Example 1-7 | 1.5 | 14 | 21003 | 7.1 | 64 | 167 | 5 | 0.21 | 0.02 | 132 | 97% | 99.30% |
| Example 1-8 | 1.5 | 20 | 12388 | 6.2 | 53 | 123 | 5.05 | 0.2 | 0.04 | 132 | 94% | 99.20% |
| Example 1-9 | 1 | 7.1 | 56393 | 8.3 | 90 | 121 | 5.7 | 1.34 | 0.09 | 129 | 100% | 99.20% |
| Example 1-10 | 2 | 7.1 | 56393 | 8.3 | 90 | 121 | 7.9 | 0.27 | 0.09 | 132 | 100% | 99.90% |
| Example 1-11 | 3 | 7.1 | 56393 | 8.3 | 90 | 121 | 9.7 | 0.23 | 0.01 | 133 | 100% | 99.90% |
| Example 1-12 | 4 | 7.1 | 56393 | 8.3 | 90 | 121 | 9.7 | 0.24 | 0.02 | 132 | 100% | 99.20% |
| Example 1-13 | 1.5 | 7.1 | 68911 | 8.4 | 53 | 123 | 6.5 | 0.26 | 0.03 | 132 | 100% | 99.50% |
| Example 1-14 | 1.5 | 6.8 | 85532 | 8.5 | 64 | 167 | 5.5 | 0.22 | 0.01 | 132 | 100% | 99.90% |

From Table 1, it can be seen that when the thickness ratio of the surface layer 20 to the base layer 10 is 1 to 4, and the melt index of the surface layer 20 at 230° C. under a load of 2.16 kg is 4 g/10 min to 20 g/10 min, the battery cell 300 can pass the thermal box test at higher temperatures, and the pass rate for high-temperature and high-humidity testing is increased. This is conducive to enhancing the encapsulation reliability of the battery cell under normal temperature conditions and rapid formation of a pressure relief channel after gas expansion in the battery cell 300 in a thermal abuse environment above 100° C., improving heat dissipation efficiency and thereby enhancing the safety performance of the battery cell 300.

From Table 1, it can be seen that when the melt index of the surface layer 20 at 230° C. under a load of 2.16 kg is 7.1 g/10 min to 12 g/10 min, and the thickness ratio of the surface layer 20 to the base layer 10 is 1.5 to 3, it is conducive for the battery cell 300 to pass the thermal box test at higher temperatures, increases the pass rate for high-temperature and high-humidity testing, and achieves a higher pass rate for voltage withstand testing.

Referring to FIG. 4, the present application also provides an electric device 400 using the above-described battery cell 300. In one implementation, the electric device 400 of the present application may be, but is not limited to, an electronic device, a drone, a backup power source, an electric automobile, an electric motorcycle, an electric motor bicycle, an electric tool, or a large household battery.

Those of ordinary skill in the art should recognize that the above embodiments are merely illustrative of the present application and are not intended to limit the present application. Any appropriate changes and variations made to the above embodiments within the essential spirit and scope of the present application fall within the scope disclosed by the present application.

What is claimed is:

1. An insulating adhesive, comprising:
a base layer;
a surface layer, wherein along a thickness direction of the base layer, at least one side of the base layer is connected to the surface layer;
a thickness ratio of the surface layer to the base layer is 1 to 4, and a melt index of the surface layer at 230° C. under a load of 2.16 kg is 4 g/10 min to 20 g/10 min.

2. The insulating adhesive according to claim 1, wherein the thickness ratio of the surface layer to the base layer is 1.5 to 3.

3. The insulating adhesive according to claim 1, wherein the melt index of the surface layer at 230° C. under a load of 2.16 kg is 6 g/10 min to 14 g/10 min.

4. The insulating adhesive according to claim 1, wherein the melt index of the surface layer at 230° C. under a load of 2.16 kg is 7.1 g/10 min to 12 g/10 min.

5. The insulating adhesive according to claim 1, wherein a melting point of the surface layer is in a range of 90° C. to 120° C.

6. The insulating adhesive according to claim 1, wherein the surface layer has at least a first melting point and a second melting point, wherein the first melting point A is in a range of 50° C.≤A≤120° C., and the second melting point B is in a range of 120° C.<B≤170° C.

7. The insulating adhesive according to claim 1, wherein a melt index of the base layer at 230° C. under a load of 2.16 kg is less than that of the surface layer, and the melt index of the base layer is 0.1 g/10 min to 5 g/10 min.

8. The insulating adhesive according to claim 1, wherein the surface layer satisfies at least one of the following conditions:
(1) a number-average molecular weight Mn of the surface layer is 10,000 g/mol to 130,000 g/mol;
(2) a weight-average molecular weight Mw of the surface layer is 100,000 g/mol to 800,000 g/mol; or
(3) a ratio Mw/Mn is 3 to 10.

9. The insulating adhesive according to claim 1, wherein a melting point of the base layer is higher than a melting point of the surface layer, and a melting point of the base layer is in a range of 140° C. to 220° C.

10. The insulating adhesive according to claim 9, wherein a number-average molecular weight of the base layer is at least 70,000 g/mol.

11. The insulating adhesive according to claim 1, wherein the surface layer has a first crystallinity and a second crystallinity, wherein the first crystallinity is 1% to 30%, and the second crystallinity is 0.01% to 5%.

12. The insulating adhesive according to claim 1, wherein a crystallinity of the insulating adhesive is 2% to 35%.

13. A tab assembly, comprising a tab and the insulating adhesive according to claim 1, wherein the insulating adhesive is connected to the tab.

14. A battery cell, comprising a battery cell casing, an electrode assembly, a tab, and the insulating adhesive according to claim 1; wherein the battery cell casing comprises a main body portion and a sealing portion, the electrode assembly is disposed within the main body portion, and the tab is connected to the electrode assembly and extends out of the sealing portion; and
the insulating adhesive is located between the tab and the battery cell casing, and the surface layer adheres to the battery cell casing and/or the tab.

15. The battery cell according to claim 14, wherein a tensile strength of the insulating adhesive at 25° C. is in a range of 5 N/mm to 10 N/mm.

16. The battery cell according to claim 14, wherein a tensile strength of the insulating adhesive at 95° C. is in a range of 0.2 N/mm to 2 N/mm.

17. The battery cell according to claim 14, wherein a tensile strength of the insulating adhesive at 120° C. is in a range of 0.01 N/mm to 0.2 N/mm.

18. The battery cell according to claim 14, wherein the tab comprises a first segment, a second segment, and a third segment; wherein
at least a portion of the first segment is connected to the electrode assembly;
the second segment is connected in a bent manner to the first segment, and the second segment accounts for 5% to 70% of a thickness of the battery cell; and
the third segment is connected in a bent manner to the second segment, and a portion of the third segment extends out of the sealing portion.

19. The battery cell according to claim 18, wherein the sealing portion comprises two adhesive layers, the sealing portion comprises a first region not overlapping with the insulating adhesive, the two adhesive layers in the first region are adhesively connected, twice a thickness of the base layer is less than a sum of thicknesses of the two adhesive layers, or a sum of thicknesses of the base layers on two sides of the tab is less than the sum of thicknesses of the two adhesive layers.

20. An electric device, comprising the battery cell according to claim 14.
